(19) United States
(12) Patent Application Publication
(10) Pub. No.: US 2007/0019321 A1
(43) Pub. Date: Jan. 25, 2007

(54) Method and apparatus for suppressing resonance of hard disk drive using notch filter

(75) Inventors: Nam-guk Kim, Anyang-si (KR); Cheol-hoon Park, Suwon-si (KR); Sang-hoon Chu, Yongin-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/491,969

(22) Filed: Jul. 25, 2006

(30) Foreign Application Priority Data
Jul. 25, 2005 (KR) 10-2005-0067291

(51) Int. Cl. G11B 5/596

(52) U.S. Cl. 360/78.04

(57) ABSTRACT

The resonance of a hard disk drive using a notch filter is suppressed by detecting a resonance frequency after a far distance search is conducted, in a state in which the notch filter is disabled, and storing the detected resonance frequency as a start frequency, determining a coefficient of the notch filter to correspond to the start frequency and enabling the notch filter, detecting a resonance frequency after a far distance search is conducted, in a state in which the notch filter is enabled, and storing the detected resonance frequency as a target frequency, and changing the coefficient of the notch filter to correspond to the target frequency.

### CROSS-REFERENCE TO RELATED APPLICATION

This application claims the benefit of Korean Patent Application No. 10-2005-0067291, filed on Jul. 25, 2005, in the Korean Intellectual Property Office, the disclosure of which is incorporated herein in its entirety by reference.

### BACKGROUND OF THE INVENTION

1. Field of the Invention

The present invention relates to a hard disk drive, and more particularly, to a method and apparatus for suppressing resonance of a hard disk drive using a notch filter.

2. Description of the Related Art

An undesired resonance of a head stack assembly used for a hard disk drive is presented by a position error signal (PES) and deteriorates stability of servo tracking operation.

FIG. 1A is a Nyquist diagram showing a case of using no notch filter. Referring to FIG. 1A, the resonance frequency existing on the left half plane of the Nyquist diagram is a component having a bad influence on the whole system. FIG. 1B are graphs showing a position error signal when a notch filter is not used in the system of FIG. 1A. According to the graph of FIG. 1B, phase is stable because a contour corresponding to the resonance frequency lies in the right half plane. Also, it can be seen that resonance with a stable phase does not influence on the position error signal.

FIG. 1C is a flow chart for explaining a conventional resonance suppression method. Referring to FIG. 1C, a basic notch filter is disabled (Operation 100). Afar distance search is conducted and a position error signal (PES) is stored (Operation 110). The far distance search can be conducted by ⅓ of a track. The stored PES is converted to a frequency spectrum using Fast Fourier Transform (FFT) (Operation 120). A frequency having a magnitude over a threshold value is detected from the converted frequency spectrum (Operation 130). When the detected frequency is out of the Nyquist frequency, the detected frequency is determined as a resonance frequency (Operation 140). A coefficient of the notch filter is selected to correspond to the determined resonance frequency (Operation 150). The notch is enabled to remove the detected resonance frequency (Operation 160).

FIG. 1D is a Nyquist diagram of a system when a notch filter is applied using the conventional resonance suppress method. In FIG. 1D, the resonance frequency component existing in the right half plane of FIG. 1A appears in the left half plane. FIG. 1E are graphs showing the position error signal when the notch filter is applied using the conventional resonance suppress method. In FIG. 1E, the position error signal is detected in a frequency band which is not shown in FIG. 1B.

However, as shown in FIGS. 1D and 1E, when the resonance frequency is detected and the notch filter is applied, the phase changes so that an unexpected result can occur.

That is, in the conventional resonance suppress method, when the resonance frequency that is not identified by the position error signal or excitation because of a stable phase completes a resonance frequency identification process and the notch filter is enabled, the phase characteristic of resonance is changed so that the resonance has a bad influence on the whole system. Thus, according to the conventional resonance suppress method, the resonance frequency cannot be suppressed when the resonance frequencies are relatively closed to each other.

### SUMMARY OF THE INVENTION

Additional aspects and/or advantages of the invention will be set forth in part in the description which follows and, in part, will be apparent from the description, or may be learned by practice of the invention.

To solve the above and/or other problems, the present invention provides a method for suppressing resonance of a hard disk drive using a notch filter which can effectively suppress resonance by applying the notch filter during detection of a resonance frequency and changing the coefficient of the notch filter to correspond to the change in the resonance characteristic when the phase characteristic of the resonance is changed by the notch filter.

The present invention provides an apparatus which employs the above resonance suppress method using the notch filter.

According to an aspect of the present invention, the resonance of a hard disk drive using a notch filter is suppressed by detecting a resonance frequency after a far distance search is conducted, in a state in which the notch filter is disabled, and storing the detected resonance frequency as a start frequency, determining a coefficient of the notch filter to correspond to the start frequency and enabling the notch filter, detecting a resonance frequency after a far distance search is conducted, in a state in which the notch filter is enabled, and storing the detected resonance frequency as a target frequency, and changing the coefficient of the notch filter to correspond to the target frequency.

According to another aspect of the present invention, an apparatus for suppressing resonance of a hard disk drive using a notch filter includes a servo controller receiving a position error signal after a hard disk drive search operation is completed and outputting a position control signal based on the received position error signal, a programmable notch filter removing a resonance frequency by filtering the position control signal output from the servo controller, and changing a filter coefficient, a voice coil motor actuator receiving the position control signal output from the programmable notch filter, performing the hard disk drive search operation, and outputting the position error signal, a resonance frequency detection portion detecting a resonance frequency on the hard disk drive, storing as a start frequency the resonance frequency detected in a state in which the programmable notch filter is disabled, storing as a target frequency the resonance frequency detected in a state in which the programmable notch filter is enabled, and outputting information on the detected resonance frequency, a notch filter coefficient generation portion receiving the information on the resonance frequency output from the resonance frequency detection portion and determining a notch filter coefficient to correspond to the detected resonance frequency, and a notch filter control portion having a notch filter coefficient determination mode, and, when a hard disk drive system is changed to the notch filter coefficient determination mode, setting the notch filter coefficient determined by the notch filter coefficient generation portion as the filter coefficient of the notch filter after disabling the programmable notch filter and performing a hard disk drive search operation, setting the notch filter coefficient output from the notch filter coefficient generation portion as the filter coefficient of the programmable notch filter after enabling the programmable notch filter and performing a hard disk drive search operation, and terminating the notch filter coefficient determination mode.

The notch filter coefficient determination mode may be performed during the power-on of the hard disk drive system.

In the synthesizing of an exciting signal of a predetermined frequency, the exciting signal may be synthesized with not only the position control signal and the position error signal but also a control command (a track position command) that is input to the servo controller.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1A is a Nyquist diagram showing a case of using no notch filter;

FIG. 1B are graphs showing a position error signal when a notch filter is not used in the system of FIG. 1A;

FIG. 1C is a flow chart for explaining a conventional resonance suppression method;

FIG. 1D is a Nyquist diagram of a system when a notch filter is applied using the conventional resonance suppress method;

FIG. 1E are graphs showing the position error signal when the notch filter is applied using the conventional resonance suppress method;

FIG. 2 shows the configuration of a hard disk drive to which the present invention is applied;

FIGS. 3A and 3B are graphs showing the frequency response characteristic of a general hard disk drive;

FIG. 4 is a block diagram of a resonance suppression apparatus according to an embodiment of the present invention;

FIG. 5 is a block diagram of a resonance suppression apparatus according to another embodiment of the present invention;

FIG. 6 is a block diagram of a resonance suppression apparatus according to yet another embodiment of the present invention;

FIG. 7 is a block diagram of a resonance suppression apparatus according to further another embodiment of the present invention;

FIG. 8 is a flow chart for explaining a resonance suppression method according to an embodiment of the present;

FIG. 9 is a flow chart for explaining in detail the operations of detecting a resonance frequency and storing the detected resonance frequency as a start frequency, and determining a coefficient of a notch filter to correspond to the start frequency, which are shown in FIG. 8;

FIG. 10 is a flow chart for explaining in detail the operations of detecting a resonance frequency and storing the detected resonance frequency as a target frequency, and determining a coefficient of the notch filter to correspond to the target frequency, which are shown in FIG. 8;

FIG. 11 is a flow chart for explaining in detail the operations of detecting a resonance frequency and storing the detected resonance frequency as a start frequency, and determining a coefficient of a notch filter to correspond to the start frequency, which are shown in FIG. 8, according to an embodiment of the present invention;

FIG. 12 is a flow chart for explaining in detail the operations of detecting a resonance frequency and storing the detected resonance frequency as a target frequency, and determining a coefficient of the notch filter to correspond to the target frequency, which are shown in FIG. 8, according to an embodiment of the present invention;

FIG. 13A is Nyquist diagram of a system according to an embodiment of the present invention; and

FIG. 13B are graphs showing a position error signal according to an embodiment of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

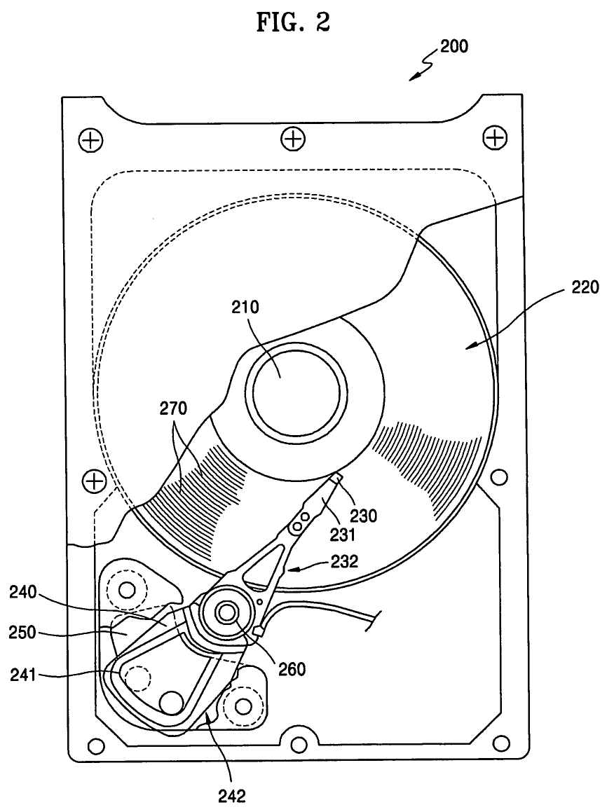

Referring to FIG. 2, a hard disk drive 200 to which the present invention is applied includes at least one magnetic disk 220 rotated by a spindle motor 210, and a head 230 located close to the surface of the disk 220. The head 230 can read or record information with respect to the disk 220 that is rotating, by detecting the magnetic field of the disk 220 and magnetizing the disk 220. Typically, the head 230 is coupled to the surface of the disk 220. Although a single head is illustrated in the drawing, the head 230 can be understood as one consisting of a read head for magnetizing the disk 220 and a write head for detecting the magnetic field of the disk 220. The read head is formed using a magneto-resistive device.

The head 230 can be incorporated into a slider 231. The slider 231 has a structure to generate an air bearing between the head 230 and the surface of the disk 220. The slider 231 is coupled to a head gimbal assembly 232 is attached to an actuator arm 240 having a voice coil 241. The voice coil 241 is located close to a magnetic assembly 250 that specifies a voice coil motor (VCM) 242. Current is supplied to the voice coil 241 which generates torque to rotate the actuator arm 240 with respect to a bearing assembly 260. The rotation of the actuator arm 240 moves the head 230 across the surface of the disk 220.

Information is typically stored in a plurality of circular tracks 270 of the disk 220. Each of the track 270 includes a plurality of sectors. Each sector includes a data field and an identification field. The identification field is formed of a gray code for identification of the sector and track (cylinder). The head 230 moves across the surface of the disk 220 to read or record information on the tracks 270.

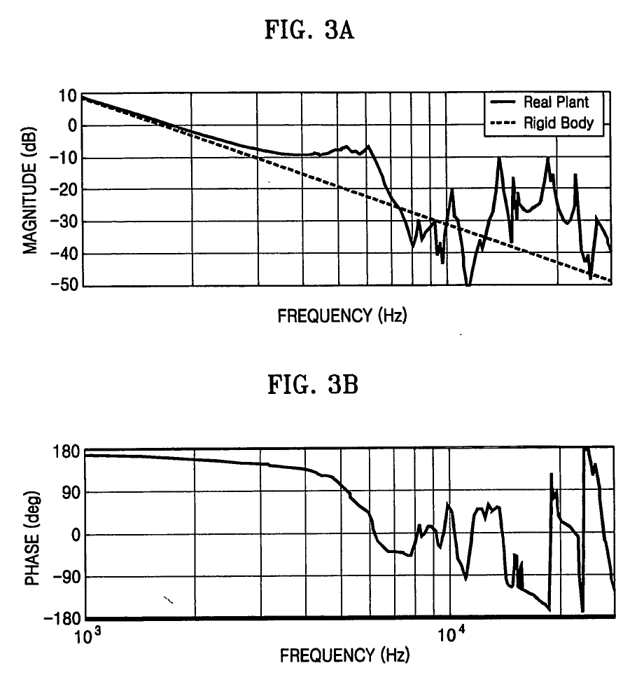

FIGS. 3A and 3B are graphs showing the frequency response characteristic of a general hard disk drive. As shown in the graphs of FIGS. 3A and 3B, in an actual hard disk drive system, mechanical resonance existing in the arm or suspension constitutes a major portion unlike an ideal model in which only rigid body motion is considered. However, since the model of the mechanical resonance is very complex and varies according to the hard disk drive system, it is practically hard to include all the mechanical resonance in a servo controller. According to an embodiment of the present invention, the mechanical resonance is suppressed by varying the filter coefficient of a notch filter according to a resonance frequency while considering the affect of the change in the resonance frequency phase due to the notch filter.

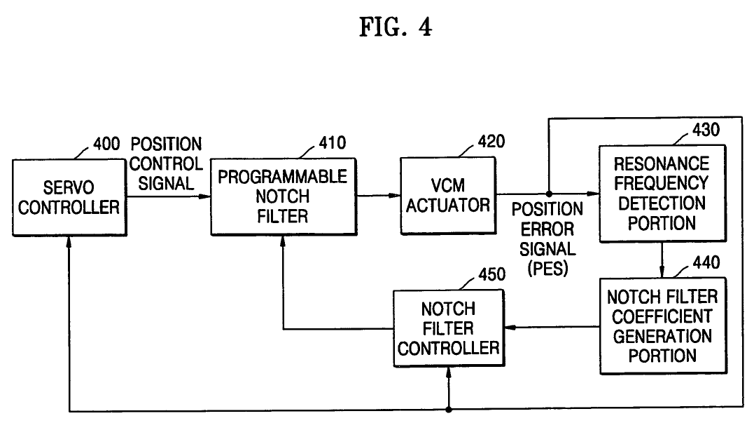

FIG. 4 is a block diagram of a resonance suppression apparatus according to an embodiment of the present invention. Referring to FIG. 4, a servo controller 400 receives a position error signal (PES) after a search operation by the hard disk drive is completed, and outputs a position control signal based on the received PES so that the head can be located at a target track on the disk.

A programmable notch filter 410 removes a resonance frequency component by filtering the position control signal output from the servo controller 400. Also, the filter coefficient of the notch filter can be varied by a notch filter controller 450 and the position control signal can be bypassed by disabling the notch filter 410.

A VCM actuator 420 receives the position control signal output from the programmable notch filter 410 and drives the VCM to locate the head at a target track on the disk. Also, while moving the head over the disk, the VCM actuator 420 compares a read servo signal with the position control signal and outputs the PES.

A resonance frequency detection portion 430 receives the PES output from the VCM actuator 420, converts the PES to a frequency spectrum, detects a resonance frequency, and outputs information on the detected resonance frequency. In particular, the resonance frequency detection portion 430 stores the detection resonance frequency as a start frequency when the programmable notch filter 410 is disabled or set with a basic filter coefficient. Also, the resonance frequency detection portion 430 stores the detection resonance frequency as a target frequency when the programmable notch filter 410 is enabled with a filter coefficient other than the basic filter coefficient.

The notch filter coefficient generation portion 440 receives the information on the resonance frequency output from the resonance frequency detection portion 430 and determines a coefficient of the notch filter that uses the detected resonance frequency as a center frequency. That is, the notch filter coefficient generation portion 440 outputs a notch filter coefficient corresponding to the resonance frequency.

The notch filter control portion 450 includes a notch filter coefficient determination mode. When the hard disk drive system is changed to the notch filter coefficient determination mode, the notch filter control portion 450 disables the programmable notch filter 410 or sets the filter coefficient of the notch filter using the basic filter coefficient stored in the system. The notch filter control portion 450 monitors the change in the PES due to the search operation of the hard disk drive.

The notch filter control portion 450 repeats by a predetermined number the operation of setting the filter coefficient of the notch filter with the notch filter coefficient output from the notch filter coefficient generation portion 440. The repetition is performed in consideration of the phase change of the resonance frequency by the notch filter 410.

The notch filter control portion 450 detects a resonance frequency which changes the maximum value in the frequency spectrum of the PES the minimum value, and determines the resonance frequency as a target frequency. A frequency which maximizes the magnitude of resonance among the resonance frequencies can be set as the target frequency. However, the when the maximum value of the magnitude of the resonance is less than a predetermined threshold value, the frequency is not detected as the resonance frequency. The notch filter control portion 450 is sets the filter coefficient of the notch filter to correspond to the target frequency and terminates the notch filter coefficient determination mode.

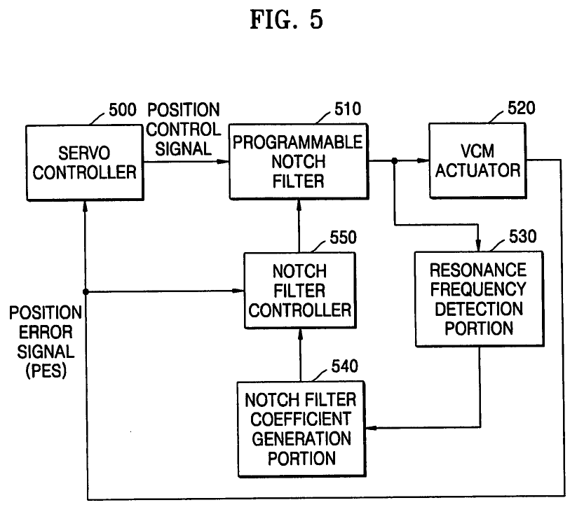

FIG. 5 is a block diagram of a resonance suppression apparatus according to another embodiment of the present invention. Referring to FIG. 5, a servo controller 500 receives a PES after the hard disk drive conducts a search, and outputs a position control signal based on the received PES so that the head can be located at a target track on the disk. A programmable notch filter 510 removes a resonance frequency component by filtering the position control signal output from the servo controller 500.

A VCM actuator 520 receives the position control signal output from the programmable notch filter 510 and drives the VCM 242 to locate the head at a target track on the disk. Also, while moving the head over the disk, the VCM actuator 520 compares a read servo signal with the position control signal and outputs the PES.

A resonance frequency detection portion 530 receives the position control signal output from the programmable notch filter 510, converts the position control signal to a frequency spectrum, detects a resonance frequency, and outputs information on the detected resonance frequency. That is, unlike the previous embodiment shown in FIG. 4, the resonance frequency is detected using not the PES, but the position control signal.

A notch filter coefficient generation portion 540 receives the information on the resonance frequency output from the resonance frequency detection portion 530 and determines a coefficient of the notch filter that uses the detected resonance frequency as a center frequency. That is, the notch filter coefficient generation portion 540 outputs a notch filter coefficient corresponding to the resonance frequency.

A notch filter control portion 550 includes a notch filter coefficient determination mode. When the hard disk drive system is changed to the notch filter coefficient determination mode, the notch filter control portion 550 disables the programmable notch filter 510 or sets the filter coefficient of the notch filter using a basic filter coefficient. Then, the notch filter control portion 550 repeats a predetermined number of times the operation of setting the filter coefficient of the notch filter with the notch filter coefficient output from the notch filter coefficient generation portion 540. Simultaneously, the notch filter control portion 550 detects a resonance frequency which minimizes the maximum value in the frequency spectrum of the PES and determines the detected resonance frequency as the target frequency. The notch filter control portion 550 sets the filter coefficient of the notch filer to correspond to the target frequency and terminates the notch filter coefficient determination mode.

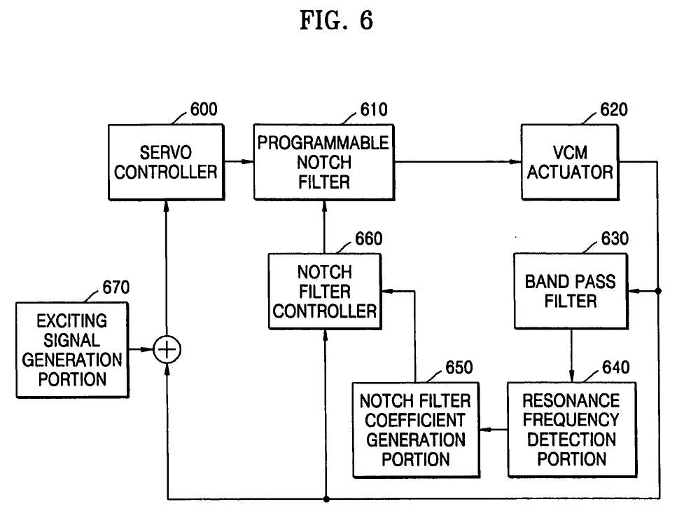

FIG. 6 is a block diagram of a resonance suppression apparatus according to yet another embodiment of the present invention. Referring to FIG. 6, a servo controller 600 receives a PES after the hard disk drive conducts a search, and outputs a position control signal based on the received PES so that the head can be located at a target track on the disk. A programmable notch filter 610 removes a resonance frequency component by filtering the position control signal output from the servo controller 600.

A VCM actuator 620 receives the position control signal output from the programmable notch filter 610 and drives the VCM to locate the head at a target track on the disk. Also, while moving the head over the disk, the VCM actuator 620 compares a read servo signal with the position control signal and outputs the PES.

A band pass filter 630 filters the PES at the frequency band of an exciting signal that is synthesized by an exciting signal generation portion 670, and outputs the filtered signal.

A resonance frequency detection portion 640 receives the PES output from the band pass filter 630, converts the position control signal to a frequency spectrum, detects a resonance frequency, and outputs information on the detected resonance frequency.

A notch filter coefficient generation portion 650 receives the information on the resonance frequency output from the resonance frequency detection portion 640 and determines a coefficient of the notch filter that uses the detected resonance frequency as a center frequency. That is, the notch filter coefficient generation portion 650 outputs a notch filter coefficient corresponding to the resonance frequency.

A notch filter control portion 660 includes a notch filter coefficient determination mode. When the hard disk drive system is changed to the notch filter coefficient determination mode, the notch filter control portion 660 disables the programmable notch filter 610 or sets the filter coefficient of the notch filter using a basic filter coefficient. Then, the notch filter control portion 660 repeats a predetermined number of times the operation of setting the filter coefficient of the notch filter with the notch filter coefficient output from the notch filter coefficient generation portion 650. In doing so, the notch filter control portion 660 detects a resonance frequency which minimizes the maximum value in the frequency spectrum of the PES and determines the detected resonance frequency as the target frequency. The notch filter control portion 660 sets the filter coefficient of the notch filer to correspond to the target frequency and terminates the notch filter coefficient determination mode.

The exciting signal generation portion 670 generates an exciting signal having a predetermined frequency and synthesizes the generated exciting signal with the PES. The predetermined frequency is one that can be altered by those skilled in the art to trace a potential resonance frequency of an actual system by arbitrarily exciting the system. The exciting signal is synthesized because, when the system is observed in view of a frequency domain, the original frequency and a mirrored frequency seem to overlap with each other. Thus, an accurate resonance frequency can be obtained by distinguishing the original frequency and the mirrored frequency by synthesizing the exciting signal and using the reaction of the system.

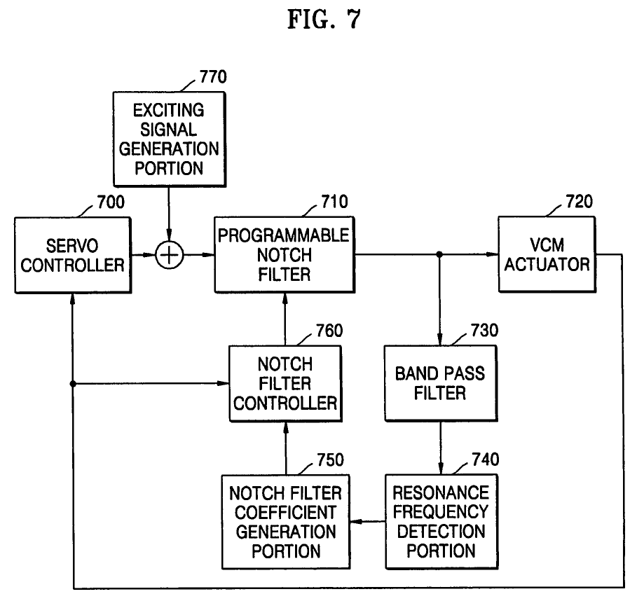

FIG. 7 is a block diagram of a resonance suppression apparatus according to further another embodiment of the present invention. Referring to FIG. 7, a servo controller 700 receives a PES after the hard disk drive conducts a search, and outputs a position control signal based on the received PES so that the head can be located at a target track on the disk. A programmable notch filter 710 removes a resonance frequency component by filtering the position control signal output from the servo controller 700.

A VCM actuator 720 receives the position control signal output from the programmable notch filter 710, and outputs the PES by comparing a read servo signal with the position control signal while moving the head over the disk.

A band pass filter 730 filters the position control signal output from the servo controller 700 at the frequency band of an exciting signal that is synthesized by an exciting signal generation portion 770, and outputs the filtered signal.

A resonance frequency detection portion 740 receives the position control signal output from the band pass filter 730, converts the position control signal to a frequency spectrum, detects a resonance frequency, and outputs information on the detected resonance frequency. Using the position control signal instead of the PES is a difference from the embodiment shown in FIG. 6.

A notch filter coefficient generation portion 750 receives the information on the resonance frequency output from the resonance frequency detection portion 740 and determines a coefficient of the notch filter that uses the detected resonance frequency as a center frequency. That is, the notch filter coefficient generation portion 750 outputs a notch filter coefficient corresponding to the resonance frequency.

A notch filter control portion 760 includes a notch filter coefficient determination mode. When the hard disk drive system is changed to the notch filter coefficient determination mode, the notch filter control portion 760 disables the programmable notch filter 710 or sets the filter coefficient of the notch filter using a basic filter coefficient. Then, the notch filter control portion 760 repeats a predetermined number of times the operation of setting the filter coefficient of the notch filter with the notch filter coefficient output from the notch filter coefficient generation portion 750. Simultaneously, the notch filter control portion 760 detects a resonance frequency which minimizes the maximum value in the frequency spectrum of the PES and determines the detected resonance frequency as the target frequency. The notch filter control portion 760 sets the filter coefficient of the notch filer to correspond to the target frequency and terminates the notch filter coefficient determination mode.

The exciting signal generation portion 770 generates an exciting signal having a predetermined frequency and synthesizes the generated exciting signal with the PES. The predetermined frequency is one that can be altered by those skilled in the art to trace a potential resonance frequency of an actual system by arbitrarily exciting the system. The exciting signal is synthesized because, when the system is observed in view of a frequency domain, the original frequency and a mirrored frequency seem to overlap with each other. Thus, an accurate resonance frequency can be obtained by distinguishing the original frequency and the mirrored frequency by synthesizing the exciting signal and using the reaction of the system.

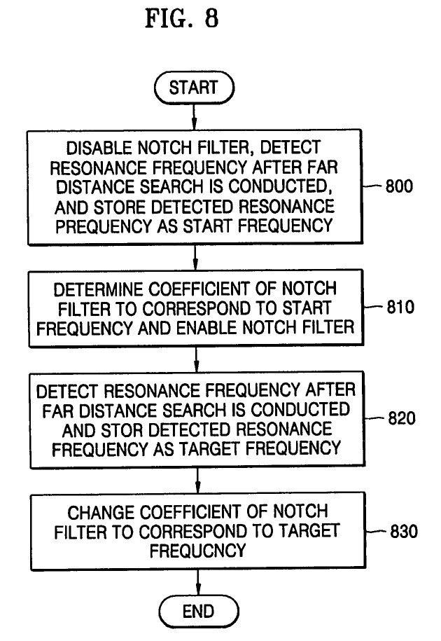

FIG. 8 is a flow chart for explaining a resonance suppression method according to an embodiment of the present. It is assumed that the hard disk drive system is changed to the notch filter coefficient determination mode.

The notch filter of the hard disk drive is disabled and a far distance search is conducted to detect a resonance frequency and stored the detected resonance frequency as a start frequency (Operation 800). According to another embodiment of the present invention, the start frequency can be detected by applying a notch filter set with a default notch filter coefficient, without disabling the notch filter.

When the notch filter is disabled, the coefficient of the notch filter is determined to correspond to the start frequency and the notch filter is enabled (Operation 810). When the notch filter is enabled, the resonance frequency after the far distance search has been conducted is detected and stored as a target frequency (Operation 820). Finally, the coefficient of the notch filter is changed to correspond to the stored target frequency (Operation 830). By changing the coefficient of the notch filter, resonance can be removed in consideration of the effect by the change of phase of the resonance frequency by the notch filter.

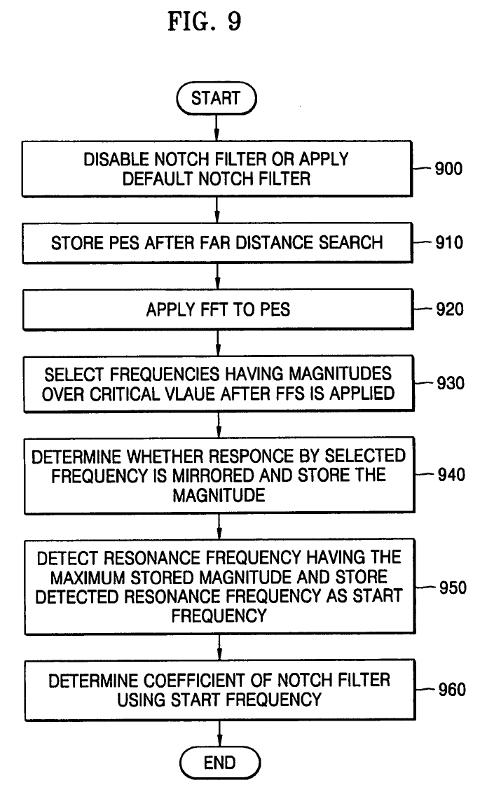

FIG. 9 is a flow chart for explaining in detail the operations of detecting a resonance frequency and storing the detected resonance frequency as a start frequency, and determining a coefficient of a notch filter to correspond to the start frequency, which are shown in FIG. 8.

First, the notch filter is disabled (Operation 900). According to another embodiment of the present invention, the notch filter set with a default notch filter coefficient can be enabled without disabling the notch filter.

When the notch filter is disabled, a far distance search is conducted on the disk and the PES is stored (Operation 910). The resonance frequency can be detected from the position control signal by storing the position control signal instead of the PES.

A frequency spectrum is generated by applying Fast Fourier Transform (FFT) to the PES (Operation 920). It can be easily identified from the frequency spectrum that the magnitude of a signal become irregular in a particular frequency.

In the frequency spectrum generated by applying the FFT, frequencies having the magnitudes over a critical value are selected (Operation 930). The critical value can be determined such that those skilled in the art determine that the magnitude of a signal makes the system unstable.

Whether the resonance by the selected frequency is mirrored and the magnitude of the resonance is stored (Operation 940). If the resonance by the selected frequency is mirrored, the selected frequency is equivalent to a resonance frequency component existing on the left half plane of the Nyquist diagram. Since the selected frequency makes the system unstable, the programmable notch filter is set to remove the resonance frequency component.

A resonance frequency having the stored magnitude that is maximum is detected and stored as a start frequency (Operation 950). That is, the resonance frequency that is most critical to the system is stored as the start frequency.

Finally, the coefficient of the notch filter is determined using the start frequency (Operation 900). When the coefficient of the notch filter changes, the center frequency of the notch filter changes accordingly and the center frequency becomes the stored start frequency.

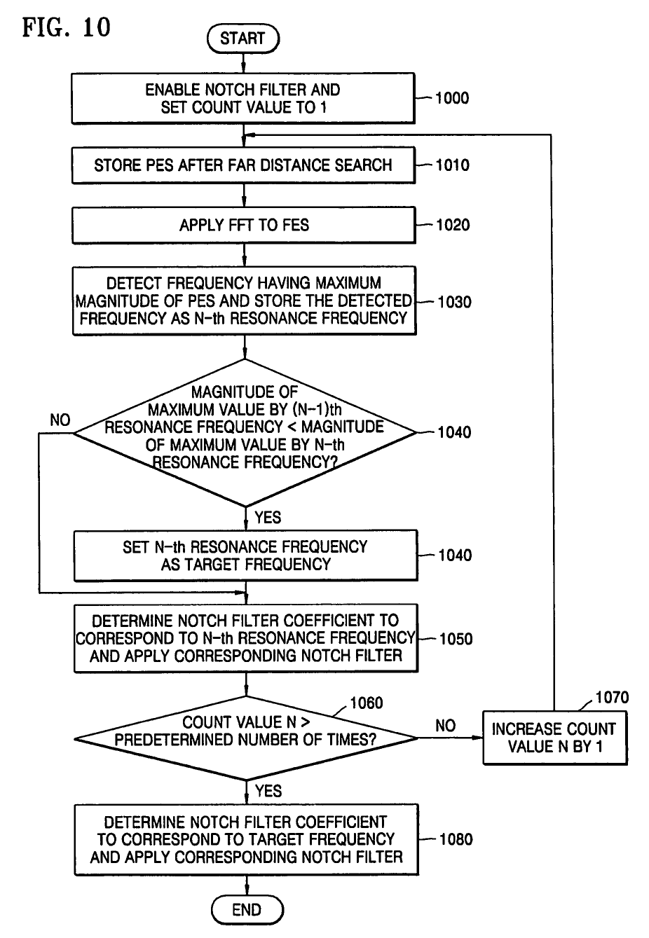

FIG. 10 is a flow chart for explaining in detail the operations of detecting a resonance frequency and storing the detected resonance frequency as a target frequency, and determining a coefficient of the notch filter to correspond to the target frequency, which are shown in FIG. 8.

First, the notch filter is enabled and a count value N is set to “1” (Operation 1000). The purpose of this operation is to consider the effect by the notch filter to the change in phase of the resonance frequency. A far distance search is conducted on the hard disk drive and the PES is stored (Operation 1010). Here, instead of the PES, the position control signal is stored to detect the resonance frequency from the position control signal. A frequency spectrum is generated by applying the FFT to the stored PES. (Operation 1020).

A frequency having the generated frequency spectrum that is over a predetermined critical value and becomes the maximum is detected and stored as the N-th resonance frequency (Operation 1030). That is, when the maximum value of the frequency spectrum is less than a predetermined threshold value, the frequency is not naturally detected as a resonance frequency.

When the maximum value of the frequency spectrum by the (N−1)th resonance frequency is less than the maximum value of the frequency spectrum by the N-th resonance frequency, the N-th resonance frequency is set as a target frequency (Operations 1040 and 1050). Otherwise, the program goes to Operation 1060. However, when the maximum value of the frequency spectrum is less than the predetermined threshold value, it is natural that the frequency is not detected as the resonance frequency.

The coefficient of the notch filter is determined to correspond to the N-th resonance frequency and a notch filter corresponding thereto is applied (Operation 1060). In this process, the resonance frequency which maximizes the maximum value of the frequency spectrum can be set as a target frequency.

When the count value N is greater than a predetermined number of repetition, the coefficient of the notch filter is determined to correspond to the target frequency and a notch filter corresponding thereto is applied (Operations 1070 and 1090). Otherwise, the count value N is increased by “1” and the program goes back to Operation 1010 to conduct the fart distance search (Operations 1070 and 1080).

Thus, the target frequency can be set more accurately and a resonance component that is most critical to the system can be removed by repeating the resonance frequency detection operations a predetermined number of times to set the target frequency.

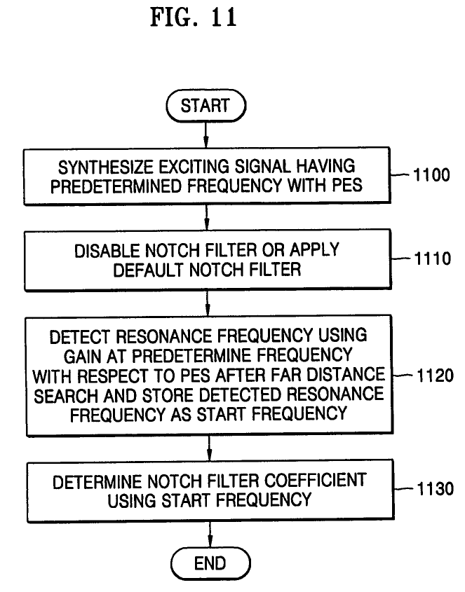

FIG. 11 is a flow chart for explaining in detail the operations of detecting a resonance frequency and storing the detected resonance frequency as a start frequency, and determining a coefficient of a notch filter to correspond to the start frequency, which are shown in FIG. 8, according to an embodiment of the present invention.

First, an exciting signal of a predetermined frequency is synthesized with the PES (Operation 1100). Here, the exciting signal of a predetermined frequency can be synthesized with the position control signal, instead of the PES. This operation is to intentionally excite the system to trace a potential resonance frequency of an actual system. The exciting signal is synthesized because, when the system is observed in view of a frequency domain, the original frequency and a mirrored frequency seem to overlap with each other. Thus, an accurate resonance frequency can be obtained by distinguishing the original frequency and the mirrored frequency by synthesizing the exciting signal and using the reaction of the system.

When the exciting signal of a predetermined frequency is synthesized with the PES, the notch filter is disabled (Operation 1110). According to another embodiment, the notch filter that is set with a default notch filter coefficient can be enabled without disabling the notch filter. Also, the position control signal can be used instead of the PES.

Next, the far distance search of the hard disk drive is conducted and the PES is stored. The resonance frequency is detected using gain of the PES in the frequency band of the exciting signal and the detected resonance frequency is stored as a start frequency (Operation 1120). In this operation, the PES is filtered using a band pass filter so that the resonance frequency can be detected only in the frequency band of the exiting signal. Also, the position control signal can be used instead of the PES.

Finally, the coefficient of the notch filter is determined using the stored start frequency (Operation 1130). It is characteristic in the present embodiment that the coefficient of the notch filter is mainly determined by setting a center frequency of the notch filter by the start frequency.

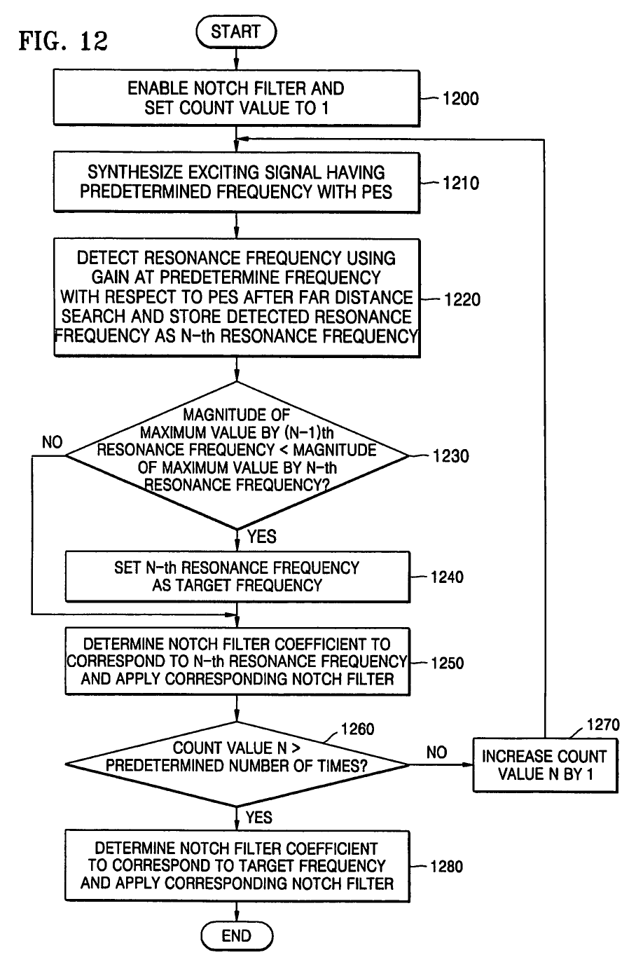

FIG. 12 is a flow chart for explaining in detail the operations of detecting a resonance frequency and storing the detected resonance frequency as a target frequency, and determining a coefficient of the notch filter to correspond to the target frequency, which are shown in FIG. 8, according to an embodiment of the present invention.

First, the notch filter is enabled and a count value N is set to “1” (Operation 1200). The purpose of this operation is to consider the effect by the notch filter to the change in phase of the resonance frequency.

An exciting signal of a predetermined frequency is synthesized with the PES (Operation 1210). Here, the exciting signal of a predetermined frequency can be synthesized with the position control signal, instead of the PES. This operation is to intentionally excite the system to trace a potential resonance frequency of an actual system.

Next, a far distance search is conducted on the hard disk drive, the PES is stored, the resonance frequency is detected using gain of the PES in the frequency band of the exciting signal, and the detected resonance frequency is stored as the N-th resonance frequency (Operation 1220). Here, the resonance frequency can be detected only in the frequency band of the exciting signal by filtering the PES using a band pass filter. Also, the position control signal can be used instead of the PES.

When the maximum value of the frequency spectrum by the (N−1)th resonance frequency is less than the maximum value of the frequency spectrum by the N-th resonance frequency, the N-th resonance frequency is set as a target frequency (Operations 1230 and 1240). Otherwise, the program goes to Operation 1250. However, when the maximum value of the frequency spectrum is less than the predetermined threshold value, it is natural that the frequency is not detected as the resonance frequency.

The coefficient of the notch filter is determined to correspond to the N-th resonance frequency and a notch filter corresponding thereto is applied (Operation 1250). In this process, the resonance frequency which maximizes the maximum value of the frequency spectrum can be set as a target frequency.

When the count value N is greater than a predetermined number of repetition, the coefficient of the notch filter is determined to correspond to the target frequency and a notch filter corresponding thereto is applied (Operations 1260 and 1280). Otherwise, the count value N is increased by “1” and the program goes back to Operation 1210 to conduct the fart distance search (Operations 1260 and 1270). Through these operations, the potential resonance of an actual system can be traced and suppressed by intentionally exciting the system.

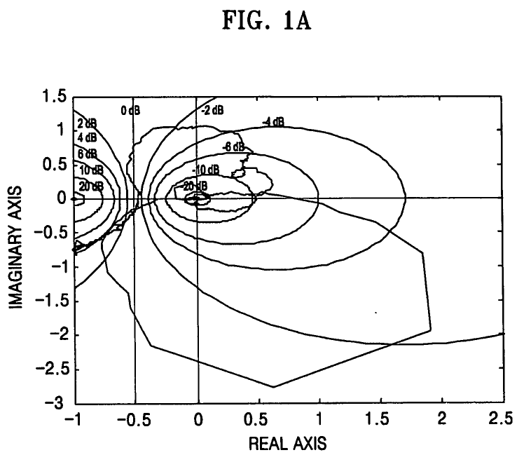

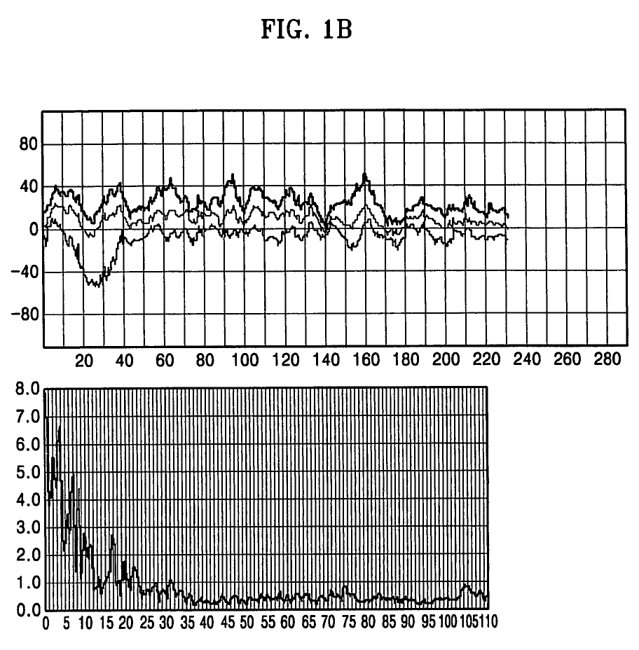

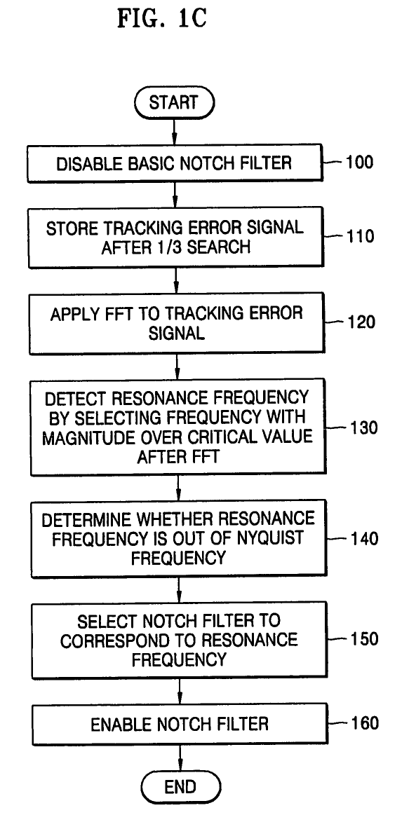

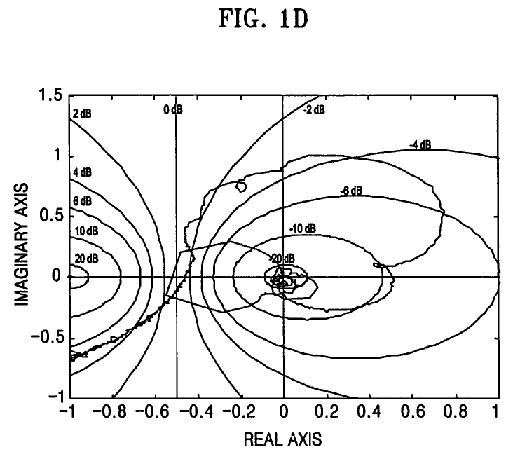

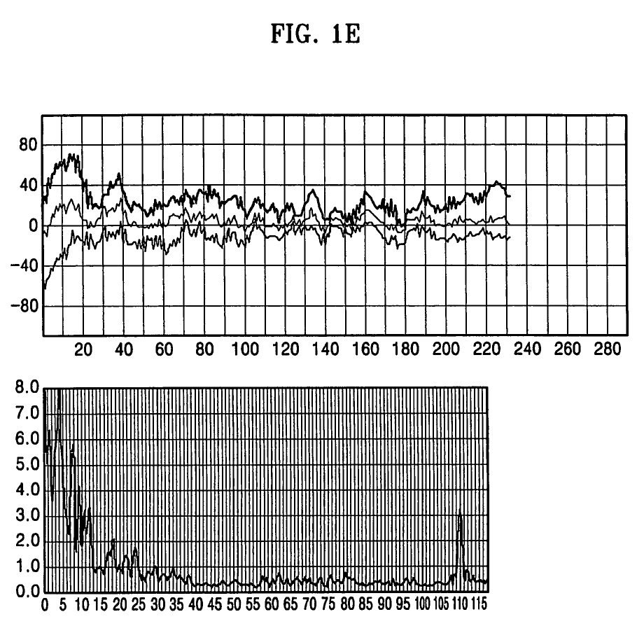

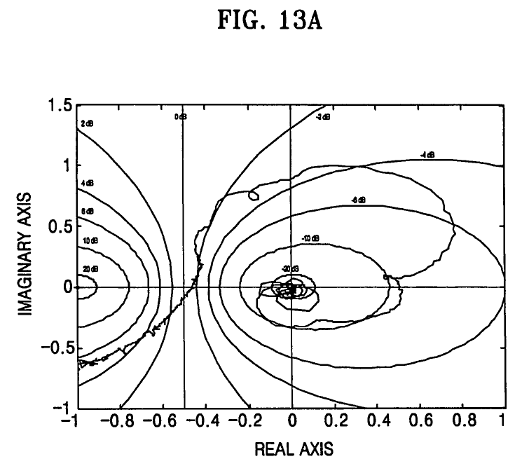

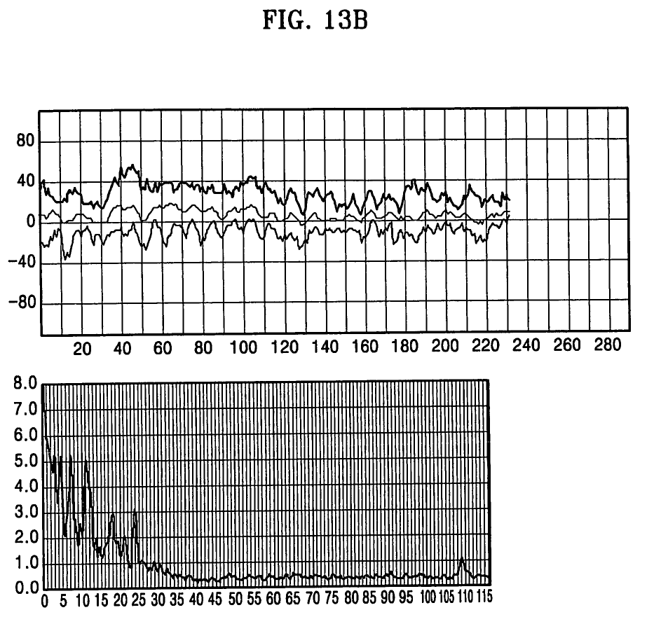

FIG. 13A is Nyquist diagram of a system according to an embodiment of the present invention. As shown in FIG. 13A, the resonance mode that is unstable after the notch filter is applied in FIG. 1D is stabilized by the present resonance suppression method. That is, according to an embodiment of the present invention, even when the notch filter is applied, the phase characteristic of the resonance frequency is located on the right half plane of the Nyquist diagram.

FIG. 13B are graphs showing a position error signal according to an embodiment of the present invention. As shown in FIG. 13B, even when the notch filter is applied, a frequency component which makes the system unstable does not appear in the PES. That is, FIG. 13B shows the PES which is quite improved compared to the PES shown in FIG. 1E according to the conventional resonance suppression method.

As described above, according to an embodiment of the present invention, since the notch filter is applied during the detection of the resonance frequency and the coefficient of the notch filter is changed to correspond to the change in the resonance characteristic, the instability of the system generated as the phase characteristic of the resonance is quickly changed by the notch filter can be prevented. When the resonance frequencies are very close to each other, the resonance frequency can be appropriately detected and suppressed.

Also, the notch filter determination mode can be performed during the power-on of the hard disk drive system. In the operation of synthesizing the exiting signal of a predetermined frequency the exciting signal can be synthesized not only with the position control signal and the PES, but also the control command (a track position command) input to the servo controller.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A method for suppressing resonance of a hard disk drive using a notch filter, the method comprising:
detecting a resonance frequency after a far distance search is conducted, in a state in which the notch filter is disabled, and storing the detected resonance frequency as a start frequency;
determining a coefficient of the notch filter to correspond to the start frequency and enabling the notch filter;
detecting a resonance frequency after a far distance search is conducted, in a state in which the notch filter is enabled, and storing the detected resonance frequency as a target frequency; and
changing the coefficient of the notch filter to correspond to the target frequency.

2. The method as claimed in claim 1, wherein, in the detecting of the resonance frequency and storing of the detected resonance frequency as a start frequency, a frequency having a magnitude of a frequency spectrum of a position error signal that is over a predetermined threshold value and is a maximum value is detected and stored as a start frequency.

3. The method as claimed in claim 1, wherein, in the detecting of the resonance frequency and storing of the detected resonance frequency as a start frequency, a frequency having a magnitude of a frequency spectrum of a position control signal that is over a predetermined threshold value and is a maximum value is detected and stored as a start frequency.

4. The method as claimed in claim 1, wherein the detecting of the resonance frequency and storing of the detected resonance frequency as a start frequency comprises:
synthesizing an exciting signal having a predetermined frequency with the position error signal; and
detecting a resonance frequency using gain of the position error signal at the predetermined frequency and storing the detected resonance frequency as a start frequency.

5. The method as claimed in claim 1, wherein the detecting of the resonance frequency and storing of the detected resonance frequency as a start frequency comprises:
synthesizing an exciting signal having a predetermined frequency with the position control signal; and
detecting a resonance frequency using gain of the position control signal at the predetermined frequency and storing the detected resonance frequency as a start frequency.

6. The method as claimed in claim 1, wherein, in the detecting of the resonance frequency and storing of the detected resonance frequency as a target frequency, a frequency having a magnitude of a frequency spectrum of a position error signal that is over a predetermined threshold value and is a maximum value is detected and stored as a target frequency.

7. The method as claimed in claim 1, wherein, in the detecting of the resonance frequency and storing of the detected resonance frequency as a target frequency, a frequency having a magnitude of a frequency spectrum of a position control signal that is over a predetermined threshold value and is a maximum value is detected and stored as a target frequency.

8. The method as claimed in claim 1, wherein the detecting of the resonance frequency and storing of the detected resonance frequency as a target frequency comprises:
synthesizing an exciting signal having a predetermined frequency with the position error signal; and
detecting a resonance frequency using gain of the position error signal at the predetermined frequency and storing the detected resonance frequency as a target frequency.

9. The method as claimed in claim 1, wherein the detecting of the resonance frequency and storing of the detected resonance frequency as a target frequency comprises:
synthesizing an exciting signal having a predetermined frequency with the position control signal; and
detecting a resonance frequency using gain of the position control signal at the predetermined frequency and storing the detected resonance frequency as a target frequency.

10. The method as claimed in claim 1, wherein the detecting of the resonance frequency and storing of the detected resonance frequency as a target frequency and the changing the coefficient of the notch filter to correspond to the target frequency are repeated a predetermined number of times.

11. A method for suppressing resonance of a hard disk drive using a notch filter, the method comprising:
applying a default notch filter coefficient that is previously stored to the notch filter of the hard disk drive and enabling the notch filter;
detecting a resonance frequency after a far distance search is conducted, in a state in which the notch filter is enabled, and storing the detected resonance frequency as a target frequency; and
changing the coefficient of the notch filter to correspond to the target frequency.

12. An apparatus for suppressing resonance of a hard disk drive using a notch filter, the apparatus comprising:
a servo controller receiving a position error signal after a hard disk drive search operation is completed and outputting a position control signal based on the received position error signal;
a programmable notch filter removing a resonance frequency by filtering the position control signal output from the servo controller, and changing a filter coefficient;
a voice coil motor actuator receiving the position control signal output from the programmable notch filter, performing the hard disk drive search operation, and outputting the position error signal;
a resonance frequency detection portion detecting a resonance frequency on the hard disk drive, storing as a start frequency the resonance frequency detected in a state in which the programmable notch filter is disabled, storing as a target frequency the resonance frequency detected in a state in which the programmable notch filter is enabled, and outputting information on the detected resonance frequency;
a notch filter coefficient generation portion receiving the information on the resonance frequency output from the resonance frequency detection portion and determining a notch filter coefficient to correspond to the detected resonance frequency; and
a notch filter control portion having a notch filter coefficient determination mode, and, when a hard disk drive system is changed to the notch filter coefficient determination mode, setting the notch filter coefficient determined by the notch filter coefficient generation portion as the filter coefficient of the notch filter after disabling the programmable notch filter and performing a hard disk drive search operation, setting the notch filter coefficient output from the notch filter coefficient generation portion as the filter coefficient of the programmable notch filter after enabling the programmable notch filter and performing a hard disk drive search operation, and terminating the notch filter coefficient determination mode.

13. The apparatus as claimed in claim 12, wherein the resonance frequency detection portion detects from the position error signal a frequency having a magnitude of a frequency spectrum of a position error signal that is over a predetermined threshold value and is a maximum value and stores the detected frequency as a start frequency.

14. The apparatus as claimed in claim 12, wherein the resonance frequency detection portion detects from the position control signal a frequency having a magnitude of a frequency spectrum of a position error signal that is over a predetermined threshold value and is a maximum value and stores the detected frequency as a start frequency.

15. The apparatus as claimed in claim 12, further comprising an exciting signal generation portion synthesizing an exciting signal having a predetermined frequency with the position error signal,
wherein the resonance frequency detection portion detects a resonance frequency using gain of the position error signal at the predetermined frequency and stores the detected resonance frequency as a start frequency.

16. The apparatus as claimed in claim 12, further comprising an exciting signal generation portion synthesizing an exciting signal having a predetermined frequency with the position control signal,
wherein the resonance frequency detection portion detects a resonance frequency using gain of the position control signal at the predetermined frequency and stores the detected resonance frequency as a start frequency.

17. The apparatus as claimed in claim 12, wherein the resonance frequency detection portion detects a frequency having a magnitude of a frequency spectrum of a position error signal that is over a predetermined threshold value and is a maximum value when the programmable notch filter is enabled, and stores the detected frequency as a target frequency.

18. The apparatus as claimed in claim 12, wherein the resonance frequency detection portion detects a frequency having a magnitude of a frequency spectrum of a position control signal that is over a predetermined threshold value and is a maximum value when the programmable notch filter is enabled, and stores the detected frequency as a start frequency.

19. The apparatus as claimed in claim 12, further comprising an exciting signal generation portion synthesizing an exciting signal having a predetermined frequency with the position error signal,
wherein the resonance frequency detection portion detects a resonance frequency using gain of the position error signal at the predetermined frequency and stores the detected resonance frequency as a target frequency.

20. The apparatus as claimed in claim 12, further comprising an exciting signal generation portion synthesizing an exciting signal having a predetermined frequency with the position control signal,
wherein the resonance frequency detection portion detects a resonance frequency using gain of the position control signal at the predetermined frequency and stores the detected resonance frequency as a target frequency.

21. The apparatus as claimed in claim 12, wherein the resonance frequency detection portion repeats a predetermined number of times the detecting of the resonance frequency and storing of the detected resonance frequency as a target frequency, and the notch filter control portion terminates the notch filter coefficient determination mode after enabling the programmable notch filter and repeating a predetermined number of time the setting of the notch filter coefficient output from the notch filter coefficient generation portion as the filter coefficient of the notch filter after performing a hard disk drive search operation.

22. An apparatus for suppressing resonance of a hard disk drive using a notch filter, the apparatus comprising:
a servo controller receiving a position error signal after a hard disk drive search operation is completed and outputting a position control signal based on the received position error signal;
a programmable notch filter removing a resonance frequency by filtering the position control signal output from the servo controller, and changing a filter coefficient;
a voice coil motor actuator receiving the position control signal output from the programmable notch filter, performing the hard disk drive search operation, and outputting the position error signal;
a resonance frequency detection portion detecting a resonance frequency on the hard disk drive, storing as a target frequency the resonance frequency detected in a state in which the programmable notch filter is set as a basic filter coefficient, and outputting information on the detected resonance frequency;
a notch filter coefficient generation portion receiving the information on the resonance frequency output from the resonance frequency detection portion and determining a notch filter coefficient to correspond to the detected resonance frequency; and
a notch filter control portion having a notch filter coefficient determination mode, and, when a hard disk drive system is changed to the notch filter coefficient determination mode, setting the programmable notch filter with a basic filter coefficient and setting the notch filter coefficient determined by the notch filter coefficient generation portion as a filter coefficient of the programmable notch filter after performing a hard disk drive search operation, and terminating the notch filter coefficient determination mode.

23. A computer having the hard disk drive of claim 22.
